(19) United States
(12) Patent Application Publication
(10) Pub. No.: US 2017/0175978 A1
(43) Pub. Date: Jun. 22, 2017

(54) LIGHT HORN ARRAYS FOR DUCTED LIGHTING SYSTEMS

(71) Applicant: 3M INNOVATIVE PROPERTIES COMPANY, St. Paul, MN (US)

(72) Inventors: Karl J. L. Geisler, St. Paul, MN (US); Vadim N. Savvateev, St. Paul, MN (US); Michael A. Meis, Stillwater, MN (US); David G. Freier, St. Paul, MN (US)

(73) Assignee: 3M INNOVATIVE PROPERTIES COMPANY, St. Paul, MN (US)

(21) Appl. No.: 15/125,312

(22) PCT Filed: Mar. 20, 2015
(86) PCT No.: PCT/US2015/021739

§ 371 Date: Sep. 12, 2016

Related U.S. Application Data
(60) Provisional application No. 61/976,075, filed on Apr. 7, 2014.

(51) Int. Cl. F21V 7/04; F21V 7/22; F21S 8/04; F21V 17/06; F21V 7/00; G02B 27/30; F21V 17/00

(52) U.S. Cl. CPC F21V 7/041; G02B 27/30; F21V 7/22; F21V 17/005; F21V 17/06; F21V 7/0091; F21V 7/0083; F21S 8/046; F21Y 2115/10

(57) ABSTRACT

A light engine having an array of light horns. Each light horn has a narrow end, an open wide end, and side walls extending from the narrow end to the wide end with the side walls shaped as truncated pyramids. One or more LEDs are located at the narrow end of each of the light horns with each of the light horns providing substantially collimated light from the LEDs at the wide end.

### BACKGROUND

High-intensity sources may be built by arranging light emitting diodes (LEDs) into densely packed arrays. The LEDs are placed on a substrate adapted to provide electrical circuitry to drive them and thermal contact with them to dissipate the heat generated by the LEDs. Collimation of the light emitted by such arrays can be achieved by placing reflective surfaces enclosing the array. The height of the enclosure (collimator) in the direction perpendicular to the substrate surface containing the arrays is commensurate with the linear dimension of the array. For dense arrays, arranged as compact groups of LEDs minimizing the enclosure perimeter, the collimator height scales as a square root of the number of LEDs. A number of considerations, including manufacturing convenience, choice of driving electronics and optical design, and cooling capacity can influence the number of LEDs in such arrays and the height of collimators in the arrays.

### SUMMARY

A light engine, consistent with the present invention, includes an array of light horns. Each light horn has a narrow end, an open wide end, and side walls extending from the narrow end to the wide end with the side walls shaped as truncated pyramids. One or more LEDs are located at the narrow end of each of the light horns with each of the light horns providing substantially collimated light from the LEDs at the wide end.

A method of assembling an array of light horns, consistent with the present invention, includes the steps of providing a holder having a plurality of alignment apertures with angled side walls, placing a plurality of first shapes of the light horns into the alignment apertures, and placing a plurality of second shapes of the light horns into the alignment apertures substantially perpendicular and mated with the plurality of first shapes. The alignment apertures are used to form the light horns as truncated pyramids and maintain alignment of the horns in the array.

Ducted lighting systems can include a light engine having an array of light horns and a light duct having light-emitting panels to receive collimated light from the light engine and distribute the light via the light-emitting panels.

### BRIEF DESCRIPTION OF THE DRAWINGS

The accompanying drawings are incorporated in and constitute a part of this specification and, together with the description, explain the advantages and principles of the invention. In the drawings,

FIG. 1A shows a schematic cross-sectional view of a lighting element;

FIG. 1B shows a schematic perspective view of a lighting element;

FIGS. 2A-2E show schematic side views of lighting element orientations;

FIG. 3 shows a schematic cross-sectional view of a linear array luminaire;

FIG. 4 shows a perspective view of a rectangular array luminaire;

FIGS. 5A-5C show schematic side views of luminaire illumination;

FIG. 6 shows a tilted perspective view of a luminaire;

FIG. 7 shows an SEM image of a redistribution plate surface;

FIG. 8 is a perspective view of a light horn array for ducted lighting systems;

FIG. 9 is a front view of the light horn array for ducted lighting systems;

FIG. 10 is a perspective view of a holder for a light horn array;

FIG. 11 is a top view of the holder with a light horn array aligned within it;

FIG. 12 is a bottom view of the holder with a light horn array aligned within it;

FIG. 13 is a perspective view of the holder with a light horn array aligned within it;

FIG. 14 is a diagram of a first shape of a mirror used to create a light horn array;

FIG. 15 is a diagram of a second shape of a mirror used to create a light horn array;

FIG. 16 is a diagram of an alternative first shape of a mirror used to create a light horn array;

FIG. 17 is a diagram of an alternative second shape of a mirror used to create a light horn array;

FIG. 18 is a diagram illustrating an LED circuit board to accommodate an LED for a light horn;

FIG. 19 is a perspective view of a ducted lighting system using a light horn array; and

FIG. 20 is a side sectional view of a ducted lighting system using a light horn array.

### DETAILED DESCRIPTION

Light Horns with Redistribution Plates

The present disclosure provides for advanced lighting elements, in particular solid-state lighting elements, and luminaires that include an array of lighting elements. The lighting element, and luminaires including the lighting elements can exhibit benefits that include high optical efficiency and therefore high luminous efficacy, extraordinary directional control and therefore extraordinary glare control and efficacy of delivered lumens, and exceptional mixing of individual-device emission providing exceptional suppression of punch-through and color breakup. In many cases, the architecture can be amenable to low-cost manufacturing in a modular format.

Applications of the lighting elements and luminaires to large-area point lighting are not limited to indoor commercial spaces. Ruggedized versions may prove to be beneficial in point lighting of roadways, parking lots, parking garages, and/or roadway tunnels. Generally, in addition to the high optical efficiency, high luminous efficacy, and adequate mixing of individual-device emissions from existing devices, certain embodiments also provide an advantage in directional control, providing for glare reduction, and an ability to meet illumination specifications without localized over-illumination—i.e., high efficacy of delivered lumens.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

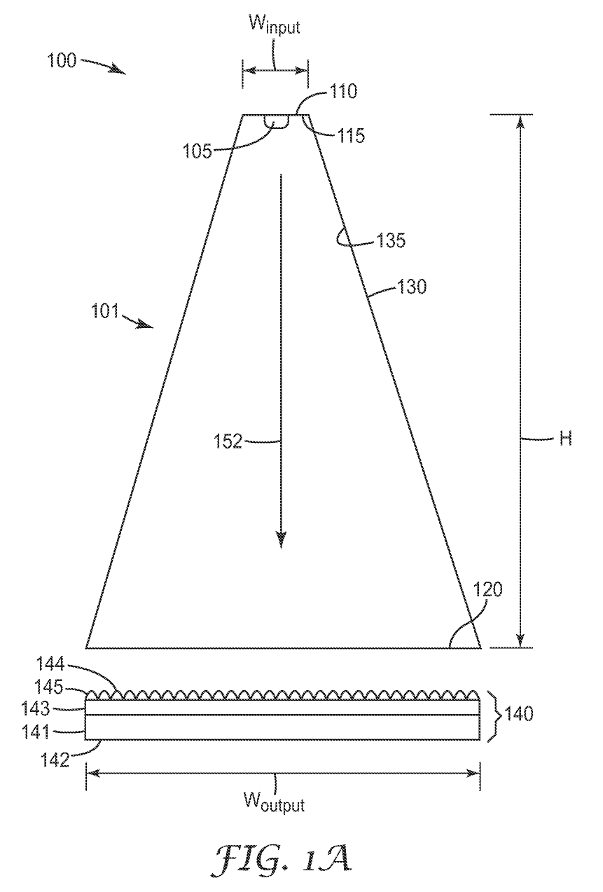

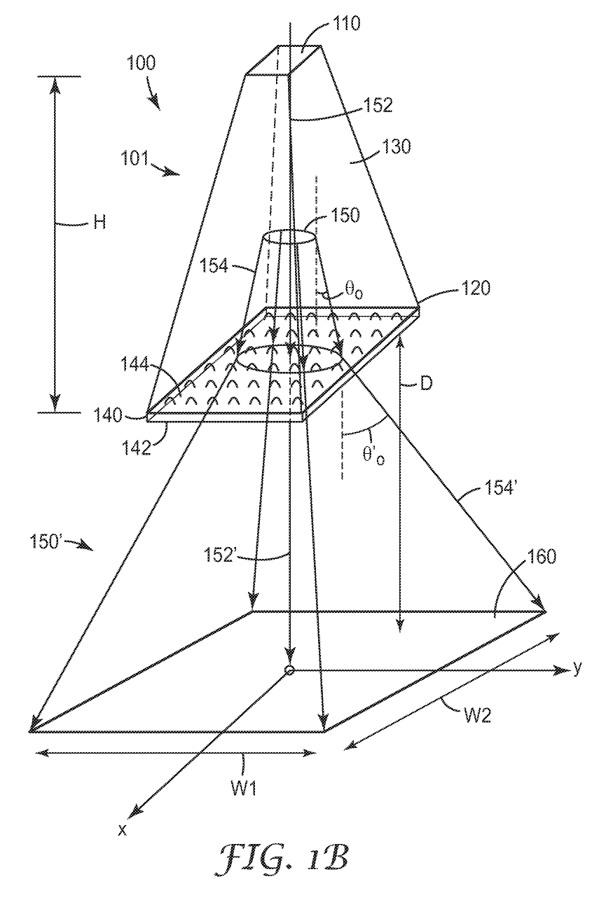

FIG. 1A shows a schematic cross-sectional view of a lighting element 100, according to one aspect of the disclosure. Lighting element 100 includes a light collimating horn 101 having an input end 110, and output end 120, and horn sidewalls 130 connecting the input end 110 to the output end 120. The lighting element 100 further includes a light source 105 disposed within the input end 110 of the light collimating horn 101, and a redistribution plate 140 disposed adjacent the output end 120 of the light collimating horn 101. The light source 105 is disposed to inject light along a pointing direction 152 running from the input end 110 to the output end 120.

The light collimating horn 101 has a height “H” between the input end 110 and the output end 120, and can have any desired cross-sectional shape perpendicular to the pointing direction 152. In some cases, the cross-sectional shape can be a circular shape, an oval shape, a rectangular shape, a square shape, a hexagonal shape, or other polygonal shapes capable of tiling a planar surface, as described elsewhere. In some cases, each dimension of the output end 120 is equal to or greater than a corresponding dimension of the input end 110. In one particular embodiment, as shown throughout the FIGS. and described herein, the cross-sectional shape can be a square shape. It is to be understood that the square shape is not to be in any way limiting, and simply serves as an example for the cross-sectional shape. Generally, the input end 110 and the output end 120 are parallel to each other; however, in some cases, they may not be parallel.

The light collimating horn 101 can be a transparent solid horn that is capable of collimating light by total internal reflection (TIR) or it can be a hollow horn that is capable of collimating light by reflection from specularly reflective interior surface. In one particular embodiment, a hollow horn is preferable, and an interior surface 135 of the light collimating horn 101 is specularly reflective. The specularly reflective interior surface 135 can be any suitable specular reflective surface including, for example, an inorganic interference reflector, an organic interference reflector, a metallic reflector, a metalized polymeric film reflector, or a combination thereof. In one particular embodiment, the specularly reflective interior surface 135 is a polymeric multilayer film such as an Enhanced Specular Reflective (ESR) film product available from 3M Company.

The geometry of the light collimating horn 101 serves to partially-collimate light injected from the light source 105, as described elsewhere. The input end 110 has an input width Wᵢₙₚᵤₜ, and includes an input end surface 115 that can be specular reflective surface, a diffuse reflective surface, or a combination thereof. The input end 110 can also include a heat sink (not shown) to extract heat generated by the light source 105. The output end 120 of the light collimating horn 101 has an output width W_{output,} and together with the height “H” and the input end 110 of the light collimating horn 101, a relationship can be derived for the degree of collimation of the input light exiting the output end 120 of the light collimating horn 101. In one particular embodiment, the relationship between the output width Wₒᵤₜₚᵤₜ , the input width Wᵢₙₚᵤₜ, and the height “H” for suitable collimation of light can be given by the expression: |Wᵢₙₚᵤₜ−Wₒᵤₜₚᵤₜ|/H≦¼.

The redistribution plate 140 is disposed adjacent the output end 120 of the light collimating horn 101, and in some cases is disposed immediately adjacent the output end 120, although in some cases, they can be separated by another optical component or an air gap. The redistribution plate includes a polymeric resin 145 having a structured refraction surface 144 facing the input end 110, an optional polymeric film support 143 onto which the polymeric resin 145 is cast, and an optional transparent support plate 141 having an opposing output surface 142, which serves as a structural support for the redistribution plate 140. Each of the structured refraction surface 144 and/or the opposing output surface 142 may include an anti-reflection coating, as known to one of skill in the art. In one particular embodiment, the structured refraction surface 144 includes tapered protrusions. The redistribution plate 140 is capable of reshaping a partially-collimated angular distribution of incident luminance from the light source 105 to match a prescribed angular distribution of transmitted luminance, as described elsewhere.

A redistribution plate generally consists of a microstructured film, comprising an optical substrate and microstructures disposed on one side of the substrate, laminated to a clear plate for structural support, as described elsewhere. In some cases, an antireflective coating can be applied on the side of the plate opposite the microstructured film, on the microstructured surface, or both. Preferably, the antireflective coating is provided on the plate side opposite the microstructured film. Alternately, the steering plate might consist of the same structured surface embossed directly on one side of the plate, with an anti-reflective coating on the other surface. In either case, the structure serves to redirect emission from the horns via refraction upon transmission so as to more closely match a prescribed angular distribution of luminance to be emitted by the luminaire. The assembled redistribution plate can be attached to the array of horns immediately adjacent to and coplanar with the output ends. In the preferred configuration, the structures on the plate face the output ends.

Given the area-averaged angular distribution of luminance exiting the horns, a characteristic index of refraction representative of the steering plate (preferably, all components possess similar indices), and the reflectivity of the AR coat for incidence from within the plate, and given a prescribed angular distribution of transmitted luminance, a distribution of surface normals for the structure is determined. When this distribution of normals is expressed in the structure of the steering plate, and the steering plate is illuminated by the horns, the squared deviation between the luminance emitted by the luminaire and that prescribed attains its minimum possible value. The minimum possible value is the minimum possible squared deviation between the prescribed distribution and that output by single-pass transmission through any single-sided structure illuminated by the input light distribution. FIG. 7 shows an SEM image of a redistribution plate surface, according to one aspect of the disclosure. It can be seen in FIG. 7, that the surface can comprise a series of protrusions having complex surface structures.

The illuminance cast upon any target surface by the luminaire can be evaluated by appropriately weighting and summing the luminance emitted in different directions. When the luminance is so weighted and summed in the deviation, the distribution of surface normals determined by the technique minimizes the squared deviation between the illuminance cast by the luminaire and that prescribed upon the target surface. Thus, structures may be selected to match either a desired distribution of emitted luminance or a desired pattern of cast illuminance. Lighting design often concerns primarily the latter.

The transmissivity of the redistribution plate is high, due to minimization of total internal reflection by the structure-up configuration, the bottom-surface AR coat, and the collimation of incidence about the normal to the plane of the plate. This attribute is in large part responsible for the high optical efficiency of the luminaire. The associated lack of reflection prohibits recycling, which in turn prohibits an increase in collimation upon incorporation of the plate. Therefore, the emission of the luminaire is comparably or less collimated than the emission of the horns. While the plate by design optimally shapes the emission to match that prescribed, close correspondence is achieved when the prescription is comparably of less collimated than the emission of the horns.

Light collimating horns generally refers to a hollow prismoid that includes two similarly-oriented rectangular apertures in disjoint parallel planes, and four trapezoidal faces connecting parallel edges of rectangles in disjoint planes. The interior surface of each trapezoidal face possesses a highly-reflective mirror finish. One aperture is designated the input end, and the other the output end. For collimating horns, each dimension of the outlet exceeds the corresponding dimension of the inlet.

In the usual circumstance, the separation “H” between the center of the input end and the center of the output end is normal to the planes containing these apertures. Then, the geometry of the collimating horn is specified by the dimensions of the input end W_{input,x}×W_{input,y} (or Wᵢₙₚᵤₜ for a square aperture) those of the output end W_{output,x}×W_{output,y} (or Wₒᵤₜₚᵤₜ for a square aperture), and the normal separation of the apertures “H”.

When an inwardly light-emitting surface occupies the input end of a sufficiently deep and highly-reflective collimating horn, the luminance exiting the output end will be substantially uniform over the outlet and confined to directions within an elliptic cone of half angles given by:

Ω_{½, x}=arcsin(W_{input, x}/W_{output, x}) and Ψ_{½, y}=arcsin(W_{input, y}/W_{output,y})
in the x and y directions, respectively. This luminance is independent of both the spatial and angular distributions of emission on the inlet.

In many cases, LEDs are the preferred source for illuminating collimating horns. The inlet may contain just one device at its center, or as many devices as are necessary to tile the entirety of its surface. In the latter case, since many LEDs are approximate Lambertian emitters, the source emission resembles Lambertian luminance uniformly filling the inlet. Since most LED packages are diffuse reflecting, the emitting surface most-closely resembles a diffuse (as opposed to specular) reflector. Further, since many lighting applications require axially-symmetric emission, we focus on a class of collimating horns for which the ratios of each dimension of the input end to the corresponding dimension of the output end is equal, and can be referred to as ‘circularly collimating’. Finally, without any real loss of generality, we can assume a square horn for which a single width Wᵢₙₚᵤₜ (herein W_{<}), Wₒᵤₜₚᵤₜ (herein W_{>}) can be used to describe the input end and output end, respectively.

The minimum half angle of collimation deliverable by a horn depends upon system requirements pertaining to adequate areal densities of delivered flux and, to a lesser extent, acceptable length. Design experience suggests ψ_{½}≈15° as reasonable benchmark limit. Accordingly, restricting use of the disclosed luminaires to applications requiring no tighter than 15-degree collimation is preferred. Fortunately, a vast number of lighting applications are included in this category. The primary exceptions are spot lighting, and narrow and medium-beam flood lighting. In much the same manner as fine detail cannot be painted with a broad brush, one also cannot expect to reproduce arbitrary changes in the prescribed luminance or illuminance which occur over angles less than 15 degrees.

The optical properties of these (and other) collimating horns can be understood within the context of a simple approximate image method, as known to one of skill in the art. Generally, the most useful collimating horns are those whose optical properties are the simplest. For example, a square horn for which (W_{>}−W_{<})/(√2H)<<1 emits the same circularly-symmetric angular distribution of luminance from every point on its outlet. Simplicity derives from configurations which force multiple reflections from the interior faces of the horn. Therefore, extreme high-reflectivity mirror finishes are a premium for useful collimating horns.

The highest-reflectivity mirror finishes known are those provided by multi-layer polymer films, such as the VIKUITI Enhanced Specular Reflective (ESR) film products, available from 3M Company. These films can be laminated to structural elements which form the side panels (trapezoidal faces) of the horn prior to assembly of these elements into a horn. They can provide specular reflectivities usually exceeding 98 percent, substantially independent of incidence angle and wavelength over the visible portions of the electromagnetic spectrum. No know metallic finishes deliver comparable levels of performance.

The sole detriment of multi-layer polymer films relative to metallic finishes is their potential photo-degradation under exposure to extreme fluxes, as might occur in collimating horns used for lighting. The areal density of potentially-harmful power incident upon the interior surfaces of the side panels of a horn as a function of position relative to the inlet can be evaluated, and may lead to the utilization of metallic finishes only in regions of harmful exposure, thereby maximally preserving the benefit of multi-layer polymer films. FIG. 1B shows a schematic perspective view of a lighting element 100, according to one aspect of the disclosure. Each of the elements 100-152 shown in FIG. 1B correspond to like-numbered elements 100-152 shown in FIG. 1A, which have been described previously. For example, input end 110 shown in FIG. 1B corresponds to input end 110 shown in FIG. 1A, and so on. In FIG. 1B, lighting element 100 shows pointing direction 152 of light collimating horn 101 is directed perpendicularly to a target surface 160 on the X-Y plane. Light source 105 (not shown) located within input end 110, injects a nearly lambertian light distribution which is shaped by reflections from the light collimating horn 101 until the light has a distribution of luminance comprising an input light beam 150 having a collimation half-angle θ₀ defined by boundary rays 154, along pointing direction 152. Input light beam 150 intercepts structured refraction surface 144 of redistribution plate 140, and reshapes the partially-collimated angular distribution of incident luminance from the light source 105 to match a prescribed angular distribution of transmitted luminance In FIG. 1B, for example, this is shown as the input light beam 150 intercepting the redistribution plate over the output end 120 is reshaped into an angular distribution of transmitted luminance 150′ that exits the opposing output surface 142 of redistribution plate 140, and intercepts the target surface 160 in a rectangular region having widths “W1” and “W2”.

It is to be understood that depending on the orientation of the pointing direction 152 (i.e., the tilt of the light collimating horn 101 relative to the target surface 160) and the design of the redistribution plate 140, an output pointing direction 152′ may not be coincident with the pointing direction 152 as shown in the FIG., but may instead be directed to another location on the X-Y plane, as described elsewhere. Generally, the output pointing direction 152′ can correspond to a central location of the angular distribution of transmitted luminance 150′ on target surface 160 from the lighting element 100, such that the position of the angular distribution of transmitted luminance 150′ can be described by an offset of the central output pointing direction 152′ from the pointing direction 152.

An input light beam 150 having light rays within an input collimation half-angle θ₀ of a pointing direction 152 (i.e., a first angular distribution of light rays), intersect the redistribution plate 140 (or film), and are converted to an angular distribution of transmitted luminance 150′ having light rays within an output collimation half-angle θ₀′ of a central output pointing direction 152′ (i.e., a second angular distribution of light rays). The redistribution plate 140 can serve the function of mixing/blending of light from a single light source, or mixing/blending light from multiple light sources. The redistribution plate 140 has a surface that includes an optimal slope distribution for reshaping the input light beam 150 in order to match a prescribed distribution of transmitted light. For each combination of input light beam 150 and desired angular distribution of transmitted luminance 150′, there is a family of surfaces that have a slope distribution suitable to effect the transformation; however, the optimal slope distribution most closely matches the desired light output.

The majority of the input light rays pass through the structured refraction surface 144 of the redistribution plate 140, are refracted into different directions determined by the local slope of the structure, and pass through the opposing output surface 142 in an output direction. For these light rays, there can be, if desired, no net change in the direction of propagation along the pointing direction 152; however, the structured refraction surface 144 can include microstructures such as tapered protrusions that can effect a change in the direction of propagation in two orthogonal directions. In some cases, the tapered protrusions can be complex shapes that include local slopes that are calculated by iterative, numerical, or analytical techniques in order to distribute the incident light in more complex output distribution. In some cases, the tapered protrusions can be arranged in a random pattern, arranged in a rectangular pattern, arranged in a square pattern, arranged in a hexagonal pattern, arranged in a herringbone pattern, or arranged in a combination pattern thereof.

The net change in direction is determined by the index of refraction and the distribution of surface slopes of the structure. The redistribution plate microstructure can include smooth- or irregular-curved surfaces similar to spherical or aspheric lenses, or can be piecewise planar, such as to approximate smooth curved lens structures, or can include diffuser characteristics, holographic characteristics, Fresnel characteristics, and the like. In general, the structured refraction surface 144 of the redistribution plate 140 can be selected to yield a specified distribution of illuminance upon target surfaces 160 occurring at distances “D” from the output end 120 which are large compared to the cross-duct dimension of the emissive surface (i.e., the far-field image). The structured refraction surface 144 of the redistribution plate 140 can also be selected to yield homogenization of the uniformity of both color and intensity of light intercepting the target surface 160.

The redistribution plate 140 can be designed, for example, such that for a conical distribution of light input to the redistribution plate 140, the light output can be a square or rectangular distribution of light output. In one particular embodiment, the redistribution plate 140 was designed to take an input distribution of luminous intensity that was essentially uniform in a cone having a collimation half-angle θ_{O} (i.e., input light beam 150 having a central light ray coincident with pointing direction 152, boundary rays 154 and collimation angle θ₀), and convert it to an output angular distribution of transmitted luminance 150′ having a central output pointing direction 152′, boundary rays 154′ and maximum output collimation half-angle θ₀′) that was essentially uniform on a rectangular target surface 160 having side lengths “W1” and “W2” located a distance “D” from the exit of the redistribution plate 140, and perpendicular to the pointing direction 152. The output distribution of luminous intensity is thus confined primarily to a beam having a maximum output collimation half-angle θ_{O}′.

For the design of this redistribution plate 140, the input end 110 was assumed to be small relative to the other dimensions (i.e., the distance from the plate to the target, “D”, and the size of the target, “W1”×“W2”), and the input distribution of light can be defined in terms of luminous intensity (Watts/Steradian) and not luminance (Watts/sq-meters/Steradian). In one particular embodiment, the angular distribution of transmitted luminance 150′ casts a prescribed distribution of illuminance upon a target surface 160 that is separated from the output end by a distance greater than four times a maximum dimension of the output end 120.

In general, the redistribution plate 140 can be designed such that an input light with a first distribution and collimation angle is mapped to an output distribution that is within 70% of a calculated illuminance value, or within 75% of a calculated illuminance value, or within 80% of a calculated illuminance value, or within 85% of a calculated illuminance value, or even within 90% or more of a calculated illuminance value. The calculated illuminance value can be determined by the minimum that is specified for use in the illuminated area.

In one particular embodiment, the squared deviation between an attained angular distribution of transmitted luminance and the prescribed angular distribution of transmitted luminance is a minimum value, as described elsewhere. In some cases, the structured refraction surface 144 is designed such that an input light beam 150 having a first distribution and collimation angle is mapped to an output distribution having a root mean square (RMS) deviation from the prescribed distribution of no more than 1.30 times the minimum value, or no more than 1.25 times the minimum value, or no more than 1.15 times the minimum value, or no more than 1.10 times the minimum value. The minimum possible value is the minimum possible squared deviation between the prescribed distribution and that output by single-pass transmission through any single-sided structure illuminated by the input light distribution.

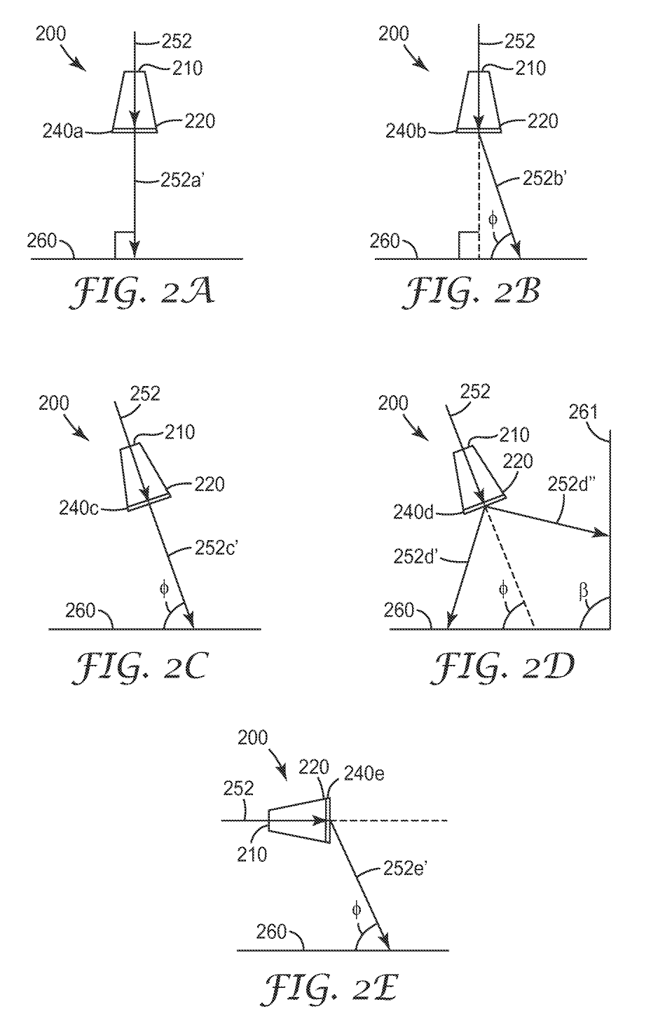

FIGS. 2A-2E show schematic side views of lighting element orientations, according to one aspect of the disclosure. Each of the elements 200-260 shown in FIGS. 2A-2E correspond to like-numbered elements 100-160 shown in FIG. 1B, which have been described previously. For example, input end 210 shown in FIG. 2A corresponds to input end 110 shown in FIG. 1B, and so on. FIG. 2A shows lighting element 200 aligned such that the pointing direction 252 is perpendicular to the target surface 260. A redistribution plate 240a can be designed such that the output pointing direction 252a′ is coincident with pointing direction 252.

FIG. 2B shows lighting element 200 aligned such that the pointing direction 252 is perpendicular to the target surface 260. A redistribution plate 240b can be designed such that the output pointing direction 252b′ is not coincident with pointing direction 252, but instead intercepts target surface 260 at an intercept angle φ.

FIG. 2C shows lighting element 200 aligned such that the pointing direction 252 is oriented at an intercept angle φ to the target surface 260. A redistribution plate 240c is designed such that the output pointing direction 252c′ is coincident with pointing direction 252.

FIG. 2D shows lighting element 200 aligned such that the pointing direction 252 is oriented at an intercept angle φ to the target surface 260. A redistribution plate 240d can be designed such that the output pointing direction 252d′ is not coincident with pointing direction 252, but either intercepts target surface 260 or an alternate target surface 261 disposed at an alternate target surface angle β to target surface 260. In some cases, target surface 260 can be a floor of a room, and alternate target surface 261 can be a wall, such that alternate target surface angle β=90 degrees.

FIG. 2E shows lighting element 200 aligned such that the pointing direction 252 is oriented parallel to the target surface 260. A redistribution plate 240e can be designed such that the output pointing direction 252e′ is directed to intercept target surface 260.

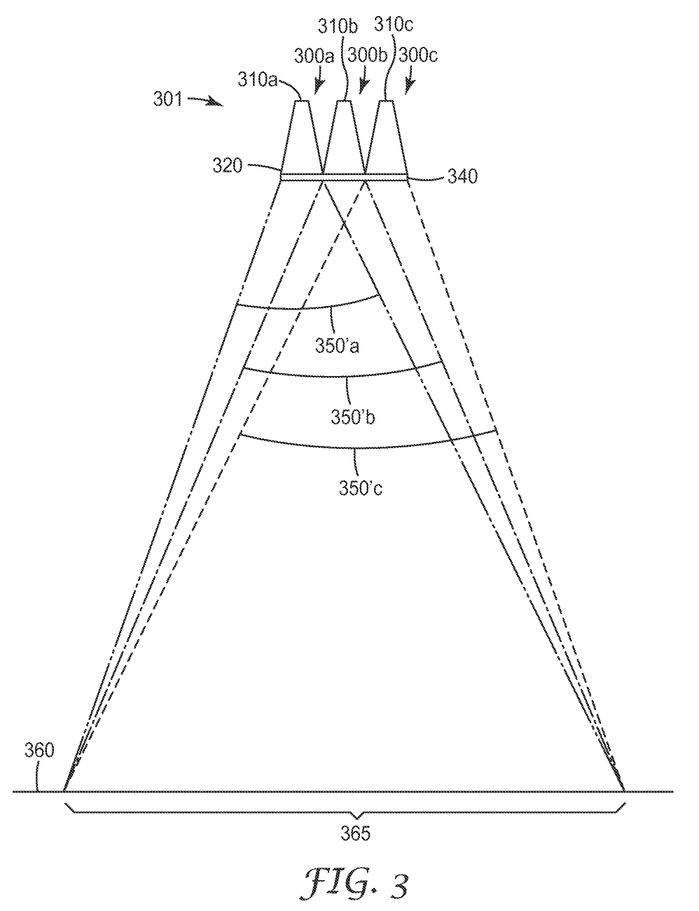

FIG. 3 shows a schematic cross-sectional view of a linear array luminaire 301, according to one aspect of the disclosure. Each of the elements 300a-360 shown in FIG. 3 corresponds to like-numbered elements 100-160 shown in FIG. 1B, which have been described previously. For example, each of input end 310a, 310b, 310c shown in FIG. 3 corresponds to input end 110 shown in FIG. 1B, and so on. In FIG. 3, linear array luminaire 310 includes a first, second, and third lighting element 300a, 300b, 300c, respectively, that can be used to illuminate an illumination region 365 of target surface 360. The first, second, and third lighting element 300a, 300b, 300c can be positioned immediately adjacent each other such that each of the associated output ends are coplanar and are tiled to uniformly fill an output end 320 emitting area, and the light redistribution plate 340 can be a unitary plate that is positioned adjacent the output end 320 emitting area. In some cases, individual light redistribution plates 340 can instead be positioned adjacent each of the first, second, and third lighting element 300a, 300b, 300c, as described elsewhere, but not shown in FIG. 3.

A first, second, and third angular distribution of transmitted luminance 350a′, 350b′, 350c′ emitted from the first, second, and third lighting element 300a, 300b, 300c, respectively, are directed toward illumination region 365. The first, second, and third angular distribution of transmitted luminance 350a′, 350b′, 350c′ are interposed on each other, such that the illuminated region 365 becomes dimmer with the removal of any of the first, second, and third lighting element 300a, 300b, 300c, but the distribution of the light across the region does not vary.

Another way of stating the uniform illumination of a surface by the luminaire is that in general, for a luminaire having an array of lighting elements, each having at least one light source, the prescribed distribution of transmitted luminance from each of the lighting elements casts a prescribed distribution of illuminance upon a target surface such that adjacent light collimating horns substantially illuminate the same target surface with the same prescribed distribution of illuminance In some cases, an intensity, but not the prescribed distribution, of the illuminance is decreased by elimination of one or more of the at least one light sources.

Longer horns having a single output end can be compared to arrays of shorter horns having a comparable combined output end. In many applications the benefits of shortening and simplified thermal management may outweigh concerns regarding non-uniformity, so that short-horn light engines can be preferred. The potential broad utility of these engines spawns the need for a low-cost means of mass production. Two innate attributes of collimating horns facilitate their low-cost fabrication. First, each horn requires only four distinct optically-active surfaces, each of which is flat. Second, most emission undergoes multiple reflections, so that the impact of unintentional non-flatness tends to average to zero. Three approaches to fabricating short-horn engines are described. Two are based upon stamping and bending ESR-lined sheet metal. The third is based upon a combination of stamped ESR-lined pieces and an aluminum extrusion.

An M×N array of illuminated horns can be fabricated by stamping and bending a suitable base plate using two types of internal pieces and two types of edge pieces. Initially, a MW_{>}×NW_{>} (or larger) base plate is fabricated containing M×N individual LEDs or LED clusters, complete with electrical and thermal connections, disposed on a square grid with pitch W_{>}, positioned centered on the plate. Then the internal and edge pieces, fabricated by stamping and bending ESR-lined sheet metal, can be attached to the base plate and/or to each other so that one LED or LED cluster is centered in the inlet of each of the resultant horns. Attachment, anchoring, and stabilization of the parts can be achieved using any combination of etched or molded guide lines or grooves in the base plate, adhesives between the pieces and the base plate, rods threaded cross-wise through the long pieces and centered to support the centerline of each small piece, or tabs and slots along the edge of each trapezoidal face, as known to one of skill in the art.

An alternate approach also based upon stamping and bending ESR-lined sheet metal can include the following steps. A linear array of horns, each having four sidewalls can be formed by inserting a horn ‘module’ including an input end and first two opposing horn sidewalls into a horn ‘rail’, which is a continuous trough having the second two opposing sidewalls, configured to accept the input end and the first two opposing horn sidewalls. Each module contributes two opposing faces and the inlet of a horn, along with an LED or LED cluster with electrical and thermal connections. The rail contributes the remaining two faces of each horn created by inserting a module. The modules can be provided with threaded posts which align with holes in the rail for alignment and attachment, and pins or wires on the inlet which align with another hole for the transfer of electrical connections exterior to the array. Rails can be provided in a single standard length NW, to accommodate an integral number N of modules, and scored at intervals of W, to permit easy separation into shorter integral segments. This architecture enables fabrication of any rectangular array from multiple copies of just two standard components. Linear segments populating a larger linear or rectangular array can be secured by a custom ESR-lined collar congruent with the perimeter of the larger array and possibly extending beneath the outlets to permit some mixing within a confined area of the output of individual horns. Such mixing can eliminate the grid of dark lines along boundaries between horns that might otherwise appear in the emission of a luminaire fed by the array.

The functionality of the rail described above might instead be provided by an aluminum extrusion whose optical surfaces are polished, vapor coated, or preferably lined with ESR. Extrusion can create a more substantial and aesthetically-pleasing device, and allows for the inclusion of additional features such as a wireway running along the input end of the rail. The extrusion can be converted to a linear array by post processing. For example, ESR-lined flat plates can be inserted into a series of cross cuts in the extrusion. Linear arrays of any integral number of elements can be created by cutting the extrusion to an appropriate length in post processing. This includes the possibility of creating individual horns as well as arrays. These linear horns might be reassembled into a linear array by, for example, passing one cylindrical support and electrical-feed rod through circular holes in the wireways of several horns, allowing for arbitrary spacing between horns and even the freedom to adjust the orientation of each horn about its pivot.

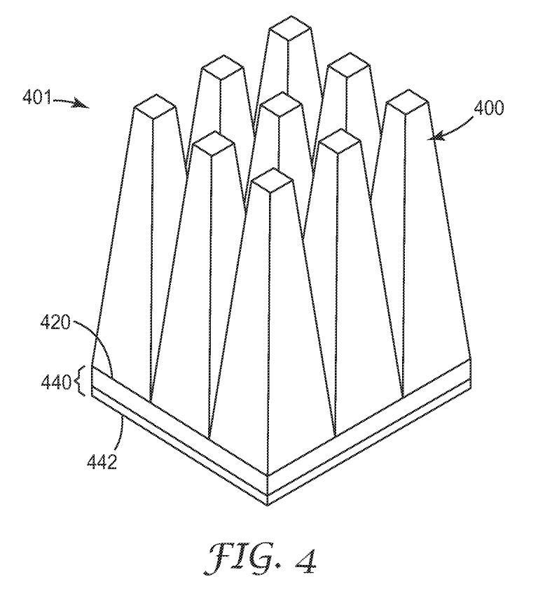

FIG. 4 shows a perspective view of a rectangular array luminaire 401, according to one aspect of the disclosure. Each of the elements 400-442 shown in FIG. 4 corresponds to like-numbered elements 100-142 shown in FIG. 1B, which have been described previously. For example, lighting element 400 shown in FIG. 4 corresponds to lighting element 100 shown in FIG. 1B, and so on. Rectangular array luminaire 401 includes a plurality of lighting elements 400 positioned immediately adjacent a neighboring lighting element 400. The rectangular array luminaire 401 can be a square array as shown in FIG. 4, or it can have other rectangular shapes. In some cases, the output ends of adjacent light collimating horns of the lighting elements 400 are coplanar and are tiled together to uniformly fill a common output end 420 emitting area, and the light redistribution plate 440 can be a unitary plate that is positioned adjacent the output end 420 emitting area. In some cases, individual light redistribution plates 440 can instead be positioned adjacent each of the lighting elements 400, as described elsewhere, but not shown in FIG. 4.

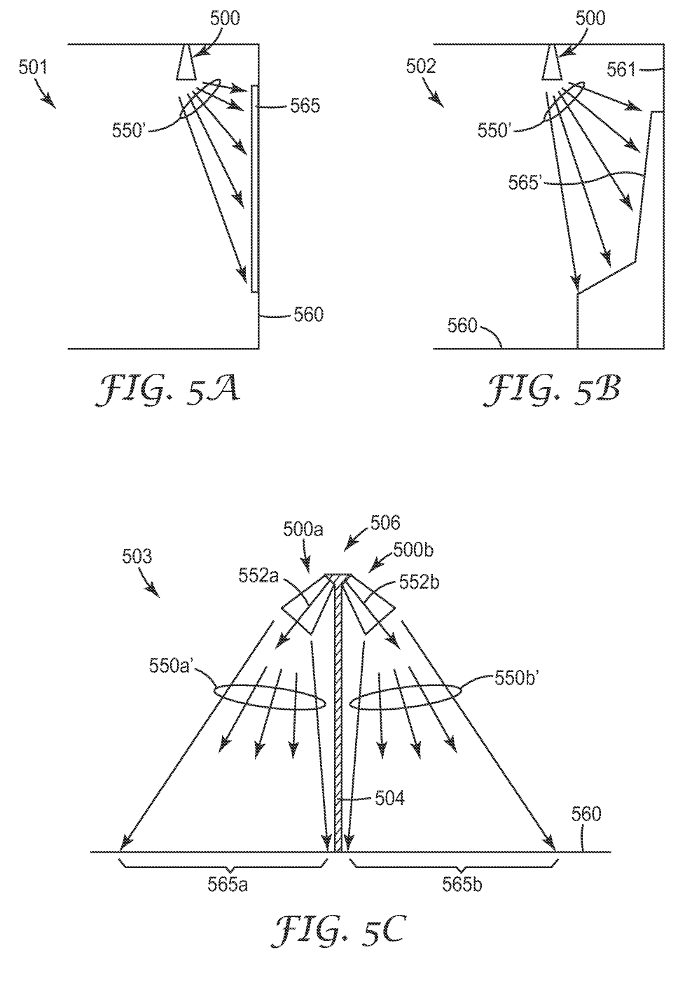

FIGS. 5A-5C show schematic side views of luminaire illumination, according to one aspect of the disclosure. In FIG. 5A, a luminaire 500 is positioned in illuminated room 501 such that an angular distribution of transmitted luminance 550′ is directed toward illuminated region 565 on target surface 560. In some cases, luminaire 500 can include only one lighting element, or it can include an array of lighting elements, as described elsewhere. In one particular embodiment, luminaire 500 can be positioned on a ceiling of illuminated room 501, and the illuminated region 565 can include, for example, artwork or a retail display positioned on the target surface 560, which can be a wall of the illuminated room 501. In some cases, luminaire 500 can extend below the ceiling as shown in FIG. 5A; however, in some cases luminaire 500 can instead be embedded within the ceiling or soffit, for aesthetics or other reasons. In one embodiment, other portions of the illuminated room 501 may lack other illumination.

In FIG. 5B, a luminaire 500 is positioned in illuminated room 502 such that an angular distribution of transmitted luminance 550′ is directed toward illuminated region 565′ on target surface 560 and alternate target surface 561. In some cases, luminaire 500 can include only one lighting element, or it can include an array of lighting elements, as described elsewhere. In one particular embodiment, luminaire 500 can be positioned on a ceiling of illuminated room 502, and the illuminated region 565′ can include, for example, artwork or a retail display positioned both on the target surface 560 (which can be a floor of the illuminated room 502), and also on the alternate target surface 561 (which can be a wall of the illuminated room 502). In some cases, luminaire 500 can extend below the ceiling as shown in FIG. 5B; however, in some cases luminaire 500 can instead be embedded within the ceiling or soffit, for aesthetics or other reasons. In one embodiment, other portions of the illuminated room 502 may lack other illumination.

In FIG. 5C, a luminaire 506 is positioned proximate the top end of a light pole 504, and can be used to illuminate a target surface 560, for example, an outdoor parking lot. In some cases (not shown), luminaire 506 can instead be positioned on the ceiling of a structure such as a parking garage, auditorium or indoor arena, and the pole may be eliminated. Luminaire 506 includes a first lighting element 500a having a first pointing direction 552a, and a second lighting element 500b having a second pointing direction 552b. First lighting element 550a directs a first angular distribution of transmitted luminance 550a′ toward a first illumination region 565a on target surface 560, and second lighting element 550b directs a second angular distribution of transmitted luminance 550b′ toward a second illumination region 565b on target surface 560. First and second illumination regions 565a, 565b can overlap, or they can be separated by a non-illuminated region.

It is to be understood that luminaire 506 can include any of the arrays of lighting elements as described elsewhere, and can also include lighting elements positioned in orientations such that the associated pointing directions point both into—and out of—FIG. 5C as illustrated. For example, in some cases, first and second pointing directions 552a, 552b, can be in a plane perpendicular to the target surface 560, and a third and fourth pointing direction (not shown) can be in a plane both perpendicular to the target surface 560, and the plane including the first and second pointing directions 552a, 552b.

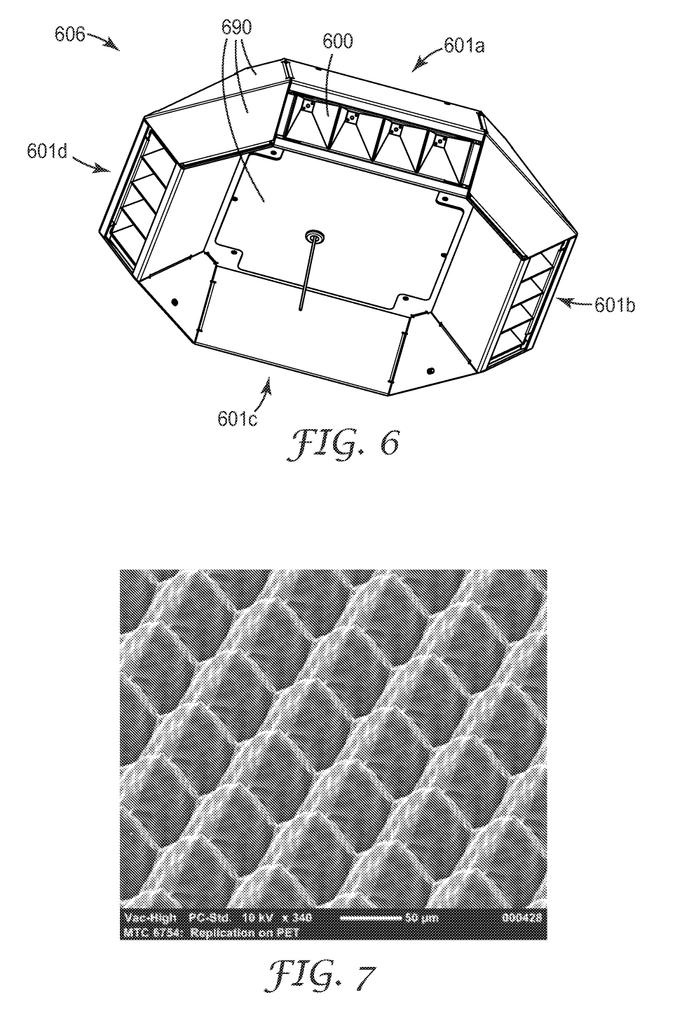

FIG. 6 shows a tilted perspective view of a luminaire 606, according to one aspect of the disclosure. In one particular embodiment, luminaire 606 can be the luminaire 506 described on the top of a light pole in FIG. 5. Luminaire 606 includes a first, a second, a third, and a fourth lighting element arrays 601a, 601b, 601c, 601d disposed in a housing 690 that at least partially encloses the arrays of lighting elements. In some cases, the housing 690 can also include a wireless control (not shown) for operation of each light source. Each of the first, second, third, and fourth lighting element arrays 601a, 601b, 601c, 601d include four lighting elements 600 disposed in a linear array. Each of the resulting 16 lighting elements are aligned such that when the luminaire 606 is positioned on the top end of the light pole, the pointing directions are collectively arranged in a four-sided pyramid shape directed toward the target surface. A separate light redistribution plate (not shown) is positioned adjacent the output end of each of the lighting elements 600, as described elsewhere. A luminaire can be constructed using multiple canted horn arrays with each horn array having a redistribution plate on the output surface. The horn arrays can be arranged to reduce the required refractive bending angle of light and assist production of a desired target coverage profile of illuminance over a target surface. Each horn array can be canted by a beam angle relative to the direction normal to the (square) target surface. Each array can be placed about the center axis so that it illuminates primarily a disjoint region of the target. In some cases, the design can allow for some overlap of the illumination profiles from the individual arrays. The redistribution plates can be designed to take overlap of the individual light sources into account.

In some cases, more than one beam angle may be employed (different arrays may be canted by different angles) to enhance the illumination in regions on the target close to or far from the axis of symmetry of the luminaire. More than one type redistribution plate may also be used on the horn arrays, depending on the horn location and/or orientation. The horn arrays on each portion of the luminaire do not have to be identical. Depending on the area of the sub-region on the target covered, any given array in the assembly might have more, less, or the same number of collimating horns and concomitant number of LEDs than others.

One benefit of the luminaire design described is that it has extremely effective thermal management properties. High power light-emitting diodes can be driven aggressively while maintaining a relatively low junction temperature. This enables a high intensity light source that also has a high luminous efficacy. A typical Cree XLamp XTE LED has a luminous efficacy equal to 122 lm/Watt, when operating at a temperature of 85 C. Integrating sphere measurements of beam modules (modular horn arrays) suggest that due to superior heat management, the horn arrays can be significantly more efficient.

### Light Horn Arrays for Ducted Lighting

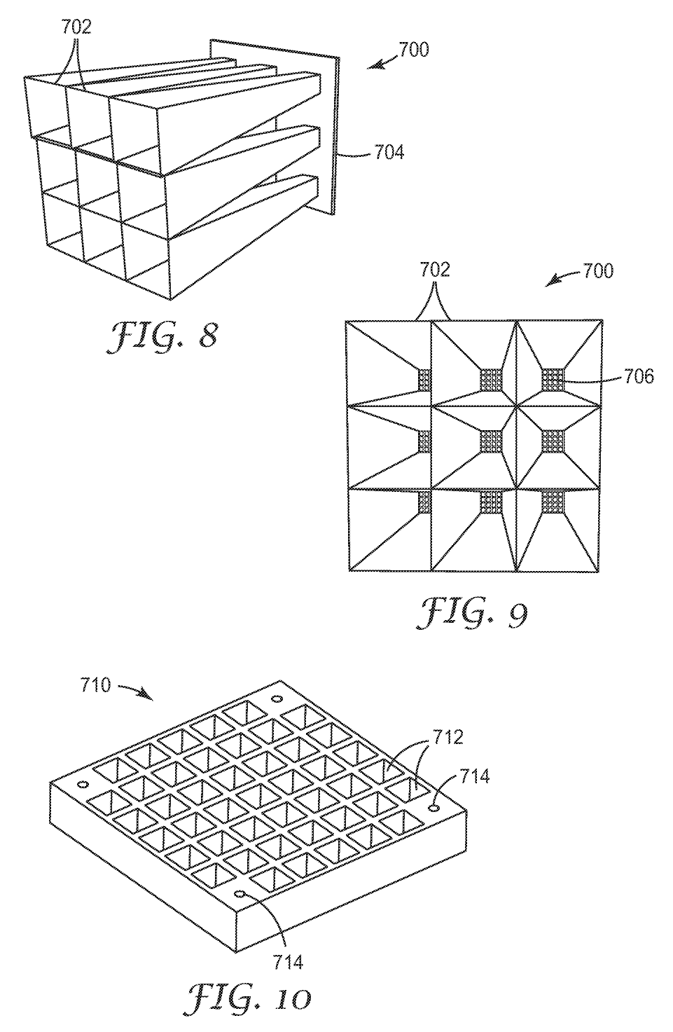

FIGS. 8 and 9 are perspective and front views, respectively, of a light horn array 700 for ducted lighting systems or other purposes. Light horn array 700 includes multiple light horns 702 having a wide end and a narrow end. One or more LEDs 706 are located at the narrow end of light horns 702. An LED board 704 supports LEDs 706 and provides for electrical connections to power the LEDs. In this example, the light horns are shaped as truncated pyramids and arranged in a closely packed array. Each light horn is configured to collimate light from the LEDs such that light from the LEDs exiting the light horn at the wide end is at least substantially collimated. In this embodiment, the light horns have an open wide end, meaning the light horns do not have redistribution plates at the wide ends.

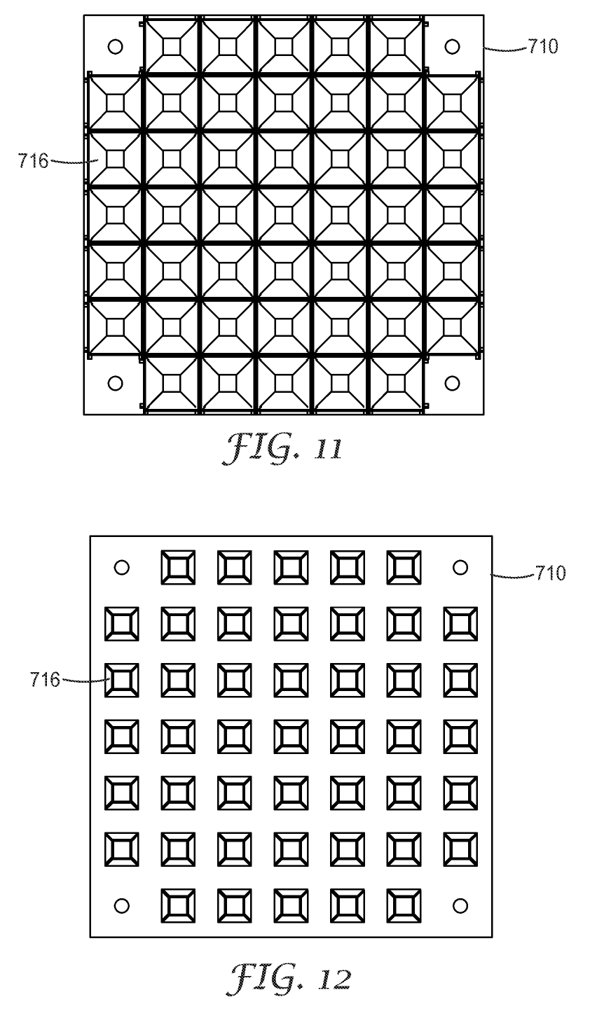

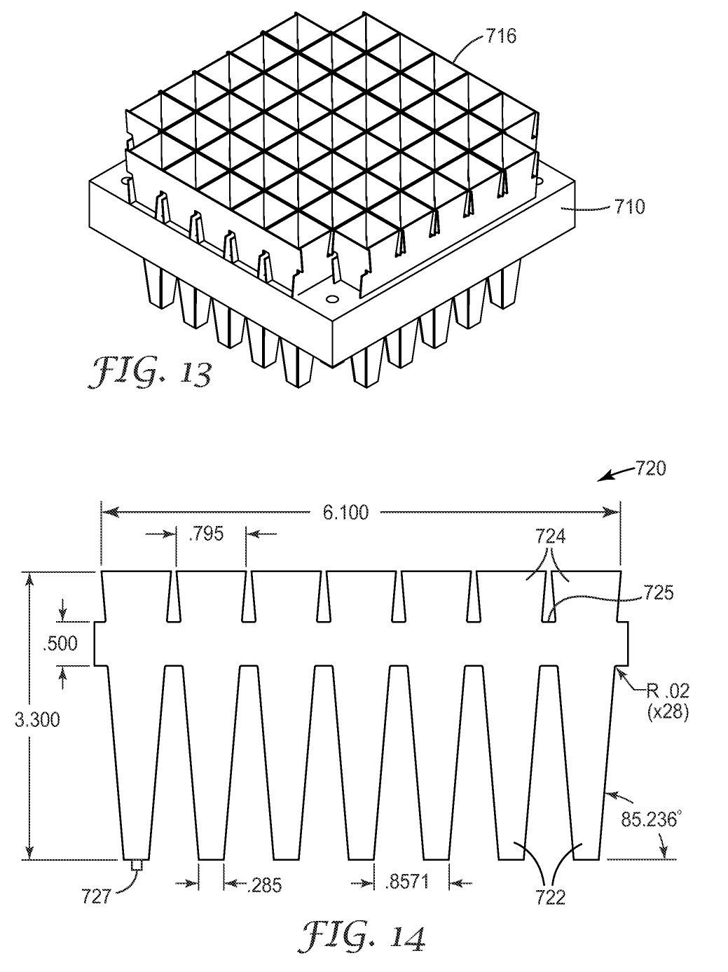

FIG. 10 is a perspective view of a holder 710 for a light horn array. Holder 710 includes alignment apertures 712 for aligning and forming the light horns and mounting apertures 714 at its corners for use in affixing the holder to an enclosure, for example. Alignment apertures 712 have angled walls at least substantially corresponding with the angle of the light horn sidewalls. FIGS. 11, 12, and 13 are top, bottom, and perspective views, respectively, of holder 710 with a light horn array 716 contained within and aligned by holder 710, illustrating how the light horn sidewalls are held within the angled walls of the alignment apertures.

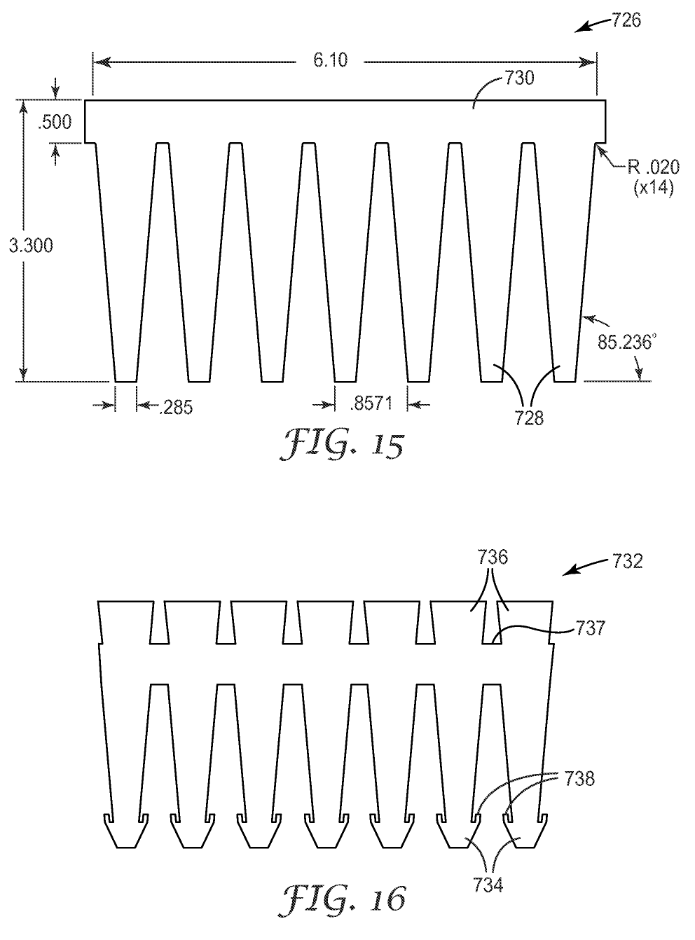

FIGS. 14 and 15 are diagrams of first and second shapes, respectively, of a mirror used to create a light horn array 716. FIG. 14 illustrates a first shape 720 for the light horns. First shape 720 includes narrow portions 722 used to form the narrow ends of the light horns and wide portions 724 used to form the wide ends of the light horns. Wide portions 724 have slots 725 between them. FIG. 15 illustrates a second shape 726 for the light horns. Second shape 726 includes narrow portions 728 used to form the narrow ends of the light horns and a wide portion 730 used to form the wide ends of the light horns. Wide portions 730 fit within slots 725 in first shape 720 when second shape 726 is mated perpendicular with first shape 720. The first or second shapes can have alignment features on their narrow portions to fit within slots on an LED board containing LEDs for the narrow ends, an example of which is alignment feature 727 shown as a tab or extended portion at one of the narrow portions 722. Other narrow portions can also have alignment features depending upon, for example, the configuration of corresponding slots on an LED board.

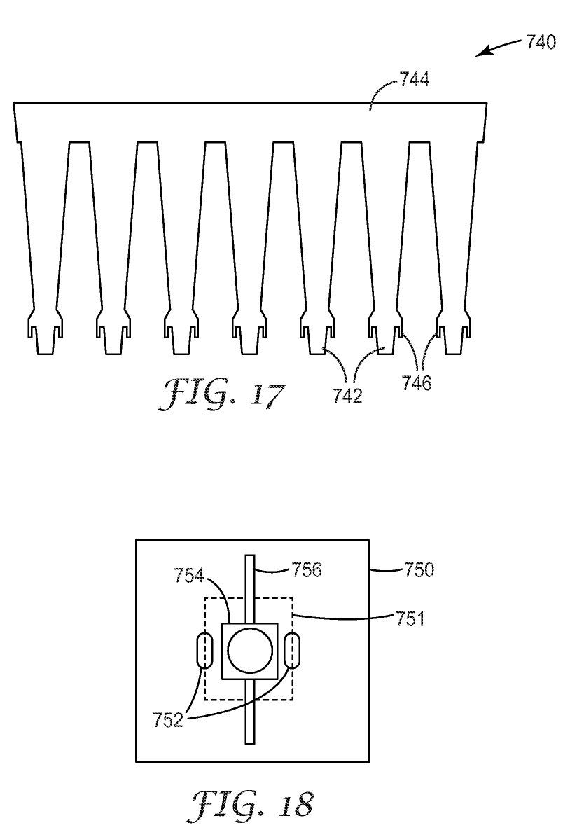

FIGS. 16 and 17 are diagrams of alternative first and second shapes, respectively, of a mirror used to create a light horn array. FIG. 16 illustrates a first shape 732 for the light horns. First shape 732 includes narrow portions 734 used to form the narrow ends of the light horns and wide portions 736 used to form the wide ends of the light horns. Narrow portions 734 have interlocking features 738. Wide portions 736 have slots 737 between them. FIG. 17 illustrates a second shape 740 for the light horns. Second shape 740 includes narrow portions 742 used to form the narrow ends of the light horns and a wide portion 744 used to form the wide ends of the light horns. Narrow portions 742 have interlocking features 746. Wide portions 744 fit within slots 737 in first shape 732 when second shape 740 is mated perpendicular with first shape 732. Also, when first shape 732 is mated with second shape 740, interlocking features 738 mate with interlocking features 746 to help hold together the sidewalls of the light horns.

FIG. 18 is a diagram illustrating an LED circuit board to accommodate an LED for a light horn. In particular, an LED board portion 750 includes an LED 754 and an LED circuit trace 756 for providing power to LED 754. Slots 752 in LED board portion 750 are used to accommodate alignment features on the narrow end of a light horn, for example alignment feature 727 shown in FIG. 14, as represented by horn placement area 751. The alignment features on the horns enter and, optionally, pass through slots or other openings on the LED board. In this example, each light horn in the array on the same LED board has only a single LED at the light horn narrow end. With only a single LED in each light horn, the light horns can have a reduced height from narrow end to wide end in comparison with using multiple LEDs in the light horns.

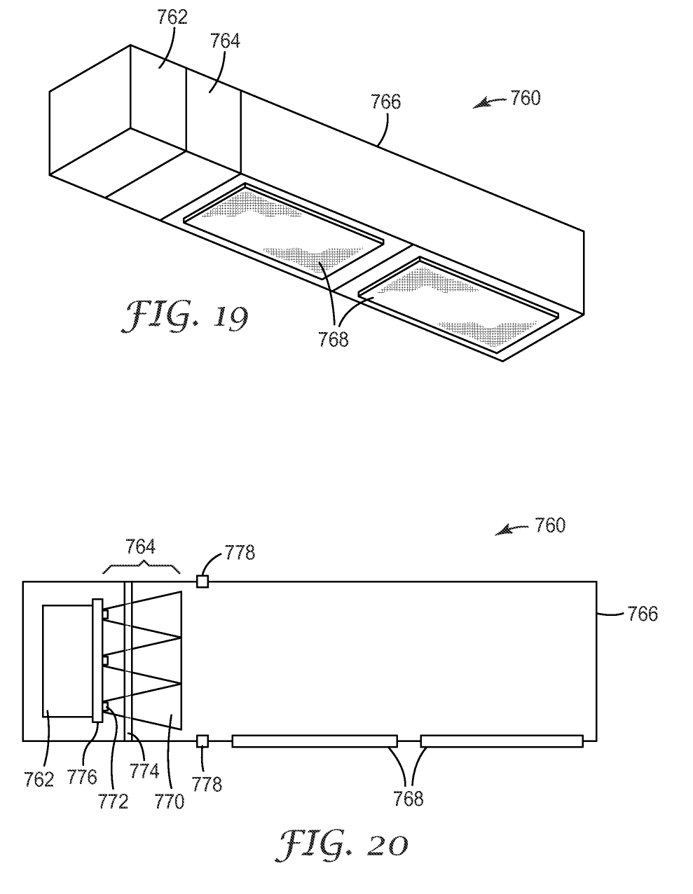

FIGS. 19 and 20 are perspective and side sectional views, respectively, of a ducted lighting system 760 using a light horn array. System 760 includes a light engine 764, a heat sink 762, and a light duct 766 having light-emitting panels 768. Light engine 764 includes light horns 770 within a holder 774 and having one or more LEDs 772 at the narrow end of each light horn. An LED board 776 provides support for and electrical connection to LEDs 772. Light engine 764 can be removable mounted to light duct 766 at mounting points 778. In use, light engine 764 provides collimated light from light horns 770 into light duct 766, and the collimated light is distributed from light duct 766 via light emitting panels 768. Light emitting panels 768 can be implemented with, for example, a structured film to redirect the collimated light out of light duct 766.

Methods to assemble a light horn array for a light engine can include the following steps.

Step 1. Start with a holder, for example holder 710, configured to have the desired number of alignment apertures for horns in the light engine.

Step 2. Insert the first shapes of the light horns into the holder through the alignment apertures. The first shapes can include, for example, first shapes 720 or 732.

Step 3. Insert the second shapes of the light horns into the holder through the alignment apertures and positioned perpendicular with the first shapes. The second shapes can include, for example, second shapes 726 or 740. For steps (2) and (3), the angled walls of the alignment apertures are used to shape the light horns into truncated pyramids. When the first and second shapes have interlocking features, for example features 738 and 746, step (3) can also involve mating the interlocking features on the first and second shapes.

Step 4. Position an LED board on the narrow ends of the light horns in the array with alignment features on the narrow portions located within slots on the LED board and with the LEDs located within the narrow ends.

Step 5. Insert the holder with light horns and the LED board into a housing.

The following are exemplary materials and configurations for the light horn arrays. The light horns can be implemented with, for example, aluminum sheet metal or plastic with a silver coating on the inside of the horns or a reflective film, such as the ESR product from 3M Company, on the inside of the horns. The first and second shapes to make the light horns can be, for example, laser cut or stamped from aluminum sheet metal. The holder can be implemented with a plastic material, for example. The heat sink be implemented with, for example, aluminum fins attached to the LED board for dissipating heat from the LEDs. A cooling fan can also optionally be used to cool the LEDs.

The light horns for ducted lighting can be arranged in an N×N array, or an M×N array where M and N are different values. The wide ends of the light horns in the array can be in physical contact with adjacent wide ends, in contact with adjacent wide ends through other components such as a frame, or be spaced apart with an air gap from adjacent wide ends. The horns are shown as truncated pyramids but can have other cross sectional shapes between the wide and narrow ends such as the following: hexagonal, octagonal, or other polygonal shapes; circular or curved; or any shape from the gamut disclosed herein, including combinations thereof. Examples of dimensions for the light horns for a particular embodiment are shown in FIGS. 14 and 15.

For ducted lighting or other purposes, the light horn array can have a small form factor by having, for example, the following features: only a single LED in each light horn; the height of each light horn being only great enough to provide the desired collimation of light at the wide (output) end of each light horn; and the wide end of each light horn in the array being in physical contact with wide ends of adjacent light horns.

The light horns for ducted lighting or other purposes can optionally include any of the features and configurations of any of the light horns described herein.

1. A light engine, comprising:
an array of light horns, each light horn comprising a narrow end, an open wide end, and side walls extending from the narrow end to the wide end, wherein the side walls are shaped as truncated pyramids; and
one or more LEDs located at the narrow end of each of the light horns,
wherein each of the light horns provides substantially collimated light from the LEDs at the wide end.

2. The light engine of claim 1, wherein each of the light horns comprises aluminum.

3. The light engine of claim 1, wherein each of the light horns comprises plastic.

4. The light engine of claim 1, wherein each of the light horns has a silver coating on an inside surface of the side walls.

5. The light engine of claim 1, wherein each of the light horns has a reflective film on an inside surface of the side walls.

6-7. (canceled)

8. The light engine of claim 1, wherein the wide end of each of the light horns is in physical contact with the wide end of an adjacent light horn.

9. The light engine of claim 1, further comprising a holder having alignment apertures configured to contain each of the light horns.

10. The light engine of claim 1, further comprising an LED board containing the LEDs and located at the narrow end of the light horns.

11. The light engine of claim 10, further comprising alignment features on one or more of the narrow ends of the light horns that enter slots or other openings on the LED board.

12. The light engine of claim 1, wherein a height of each of the light horns from the narrow end to the wide end is selected to provide a desired amount of collimation of light from the LEDs at the wide end.

13. A ducted lighting system, comprising:
a light duct having a first end and a second end opposite the first end;
one or more light-emitting panels on the light duct between the first and second ends; and
a light engine coupled the light duct at the first or second end, the light engine comprising:
an array of light horns, each light horn comprising a narrow end, an open wide end, and side walls extending from the narrow end to the wide end, wherein the side walls are shaped as truncated pyramids; and
one or more LEDs located at the narrow end of each of the light horns,
wherein each of the light horns provides substantially collimated light from the LEDs at the wide end, and the wide ends face into the light duct.

14-15. (canceled)

16. The ducted lighting system of claim 13, wherein each of the light horns has a silver coating on an inside surface of the side walls.

17. The ducted lighting system of claim 13, wherein each of the light horns has a reflective film on an inside surface of the side walls.

18-19. (canceled)

20. The ducted lighting system of claim 13, wherein the wide end of each of the light horns is in physical contact with the wide end of an adjacent light horn.

21. The ducted lighting system of claim 13, further comprising a holder having alignment apertures configured to contain each of the light horns.

22. The ducted lighting system of claim 13, further comprising an LED board containing the LEDs and located at the narrow end of the light horns.

23. The ducted lighting system of claim 22, further comprising alignment features on one or more of the narrow ends of the light horns that enter slots or other openings on the LED board.

24. The ducted lighting system of claim 13, wherein a height of each of the light horns from the narrow end to the wide end is selected to provide a desired amount of collimation of light from the LEDs as the wide end.

25. A method of assembling an array of light horns, comprising:
providing a holder having a plurality of alignment apertures with angled side walls;
placing a plurality of first shapes of the light horns into the alignment apertures; and
placing a plurality of second shapes of the light horns into the alignment apertures substantially perpendicular and mated with the plurality of first shapes,
wherein the alignment apertures are used to form the light horns as truncated pyramids.

26. The method of claim 25, further comprising mating first interlocking features on the plurality of first shapes with second interlocking features on the plurality of second shapes.
